(19) United States
(12) Patent Application Publication
(10) Pub. No.: US 2019/0166121 A1
(43) Pub. Date: May 30, 2019

(54) SYSTEM AND METHOD FOR FACILITATING THE DELIVERY OF SECURE HYPERLINKED CONTENT VIA MOBILE MESSAGING

(71) Applicant: MESSAGE 4U PTY LIMITED, Melbourne (AU)

(72) Inventors: Paul COLBY, Melbourne (AU); Anthony GIRGIS, Melbourne (AU)

(21) Appl. No.: 16/180,750

(22) Filed: Nov. 5, 2018

(30) Foreign Application Priority Data
Nov. 3, 2017 (AU) 2017904483

(51) Int. Cl. H04L 29/06; H04L 12/58; H04L 29/08; H04W 4/14; H04W 12/00; H04W 12/06

(52) U.S. Cl. CPC H04L 63/0861; H04L 51/38; H04L 67/2814; H04L 67/02; H04W 12/0013; H04W 12/06; H04W 4/14

(57) ABSTRACT

A method for sending secure content to a content recipient via a mobile device comprises receiving, by a third-party proxy service, a content delivery message containing a URL to a web resource containing the secure content. Responsive to receiving the message, the third-party proxy service: sends a message to the mobile device containing a proxied URL selectable for routing the mobile device to the secure content page, via the third-party proxy service; receives a content request from the mobile device for accessing the proxied URL; communicates with the mobile device to authenticate the user, based on biometric data provided by the user; and responsive to determining that the user is the content recipient based on a positive authentication, proxying the content request to the web resource containing the secure content.

### FIELD OF INVENTION

The present invention relates generally to a system and method for facilitating delivery of secure hyperlinked content via a mobile messaging protocol, such as short message service (SMS).

### BACKGROUND OF INVENTION

Smartphones are being increasingly used in place of traditional computing devices to receive and view electronic content. One technique for delivering electronic content to a smartphone user is via SMS (short message service). More particularly, a hyperlink to the electronic content (e.g. stored on a remote server) can be included in the SMS. The hyperlink can be readily selected by the smartphone user for accessing and subsequently presenting the content via a suitable application resident on the smartphone.

However, by default, SMS messages are not encrypted and thus are only protected by the mobile communication network itself (e.g. a GSM network). Such mobile networks may optionally employ a weak and broken stream cypher that can be exploited by attackers seeking to intercept SMS messages being communicated over the network. It would be advantageous if there was provided a means for making content delivery via SMS more secure, without significantly impacting the end recipient's experience.

### SUMMARY OF INVENTION

In accordance with a first aspect there is provided a method for sending secure content to a content recipient via a mobile device, the method comprising: receiving a content delivery message containing a URL to a web resource containing the secure content, the URL being received by a third-party proxy service; responsive to receiving the message, the third-party proxy service: a) sends a message to the mobile device containing a proxied URL selectable for routing the mobile device to the secure content page, via the third-party proxy service; b) receives a content request from the mobile device for accessing the proxied URL; c) communicates with the mobile device to authenticate the user, based on biometric data provided by the user; and d) responsive to determining that the user is the content recipient based on a positive authentication, proxying the content request to the web resource containing the secure content.

In accordance with a second aspect there is provided a system for sending secure content to a content recipient via a mobile device, the system comprising: a third-party proxy service configured to receive a content delivery message containing a URL to a web resource containing the secure content, responsive to receiving the message, the third-party proxy service further configured to: a) send a message to the mobile device containing a proxied URL selectable for routing the mobile device to the secure content page, via the third-party proxy service; b) receive a content request from the mobile device for accessing the proxied URL; c) communicate with the mobile device to authenticate the user, based on biometric data provided by the user; and d) responsive to determining that the user is the content recipient based on a positive authentication, proxying the content request to the web resource containing the secure content.

### BRIEF DESCRIPTION OF DRAWINGS

Embodiments of the present invention will now be described, by way of example only, with reference to the accompanying drawings, in which:

FIG. 1 is a schematic of a system, in accordance with an embodiment of the invention; and

FIG. 2 is a flow chart setting out a process flow, in accordance with an embodiment.

### DETAILED DESCRIPTION

Embodiments of the invention described herein relate to a system and method for securely delivering electronic content to a content recipient via mobile messaging. As will be outlined in detail in subsequent paragraphs, a third-party proxy service proxies access to content located on a server implemented by the content originator, such that access to the proxied content is advantageously protected by requiring the recipient to pass a biometric input test. For example, the biometric input could comprise a voice recording, facial image, facial video recording, iris image, 3D face structure model, fingerprint scan, or other readily-capturable biometric attribute. In the event that a hacker was to defeat the biometric authentication test, a further advantage of the system and method lies in the removal of plausible deniability. That is, if someone were to impersonate the intended recipient, that person is not able to readily claim, if prosecuted, that they were unaware they were accessing unauthorised content. Embodiments may advantageously be combined with the two-pass token based secure delivery methodology as outlined in co-pending Australian application No. 2017902935, the contents of which are incorporated herein by reference.

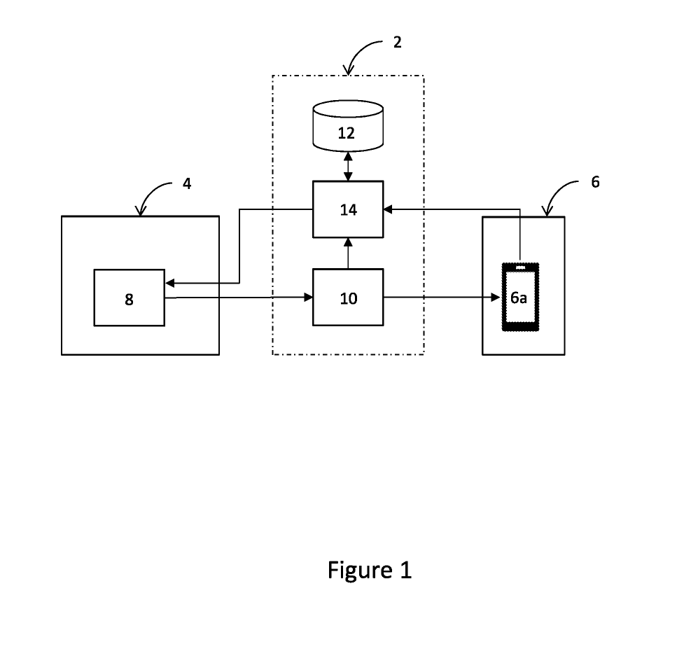

FIG. 1 depicts an example system architecture in which embodiments of the present invention can be implemented. As illustrated, the system 1 includes a secure proxy service 2 (hereafter “secure service”), a content originator 4 and a message recipient 6 operating a mobile device 6a. The content originator 4 maintains a webserver 8 storing content to be securely accessed by the message recipient 6 (“recipient”). The content originator 4 subscribes to a secure SMS service implemented by the secure service 2 that facilitates the secure delivery of the content stored on the webserver 8 to the recipient 6, by way of a SMS message. In other words, the secure service 2 operates as an intermediary third-party for ensuring digital content is delivered securely to the recipient 6. By way of example, the content originator 4 may be a medical practice that wishes to send confidential test results to a patient (i.e. the message recipient 6).

As shown in FIG. 1, the secure service 2 implements an API gateway 10, a biometric data store 12 and a webserver 14, the functions of which will be described in detail in subsequent paragraphs.

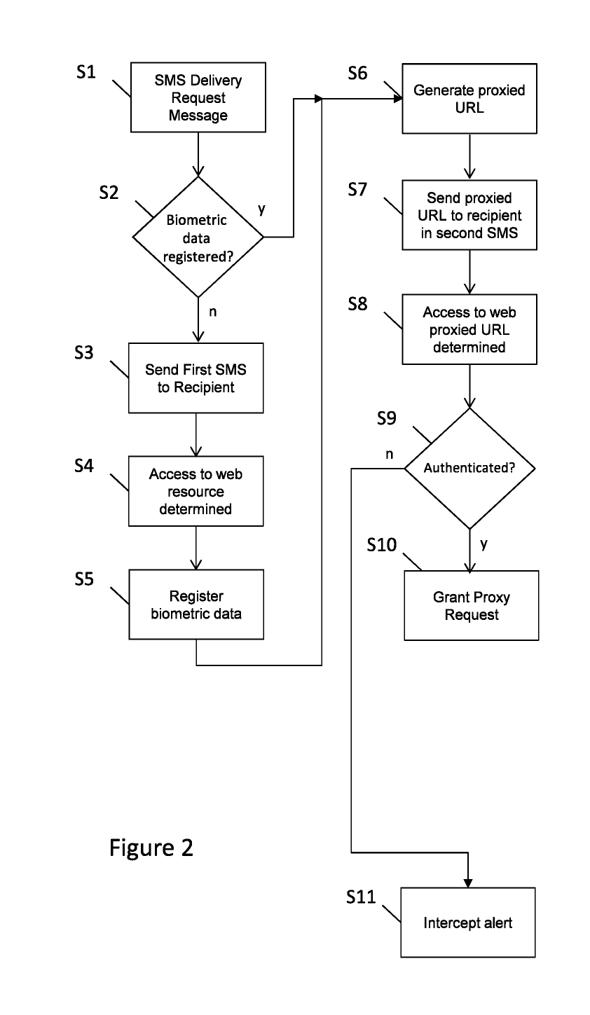

In more detail, and with additional reference to the flow chart of FIG. 2, an embodiment of the method involves the secure service 2 receiving an SMS delivery request message from the content originator 4 (step S1). The SMS delivery request message is received via the API gateway 10. The request includes a URL for accessing the content stored on the web server 8, as well as a unique identifier for either the recipient 6 and/or their device 6a. According to the illustrated embodiment, the delivery request message takes the form of a JSON (JavaScript Object Notation) document that is posted to a REST endpoint for the API gateway 10. Further, the unique identifier in this instance takes the form of the MSIDN, which persons skilled in the art will understand is a number uniquely identifying a subscription in a GSM or a UMTS mobile network which maps a telephone number to the device's SIM card. Alternatively, the unique identifier could be some other identifier (e.g. device UID) that can be used by the secure service 2 to look up the recipient's mobile phone number in a data store maintained by the secure service 2.

First Pass

At step S2, the secure service 2 determines whether the recipient 6 has previously registered a form of biometric data with the secure service 2. This involves evaluating whether there is any biometric data stored in association with the recipient's unique identifier in the biometric data store 12. If there is, the method proceeds directly to step S6, as described in the following paragraph. If not, at step S3, the secure server 2 generates and sends a first SMS message to the recipient 6. The SMS message includes a URL to a biometric data registration page stored on the web server 14. The SMS may include contextual information for the message recipient 6, such as “{insert name of message recipient} has a secure SMS waiting, please visit: https://securetxt.io/eidj78”. In response to the recipient 6 accessing the web resource (step S4), the secure service 2 communicates with the mobile device 6a to receive a form of biometric data from the user (step S5). In an embodiment this involves initiating a registration session with the mobile device, whereby the mobile device is controlled to capture biometric data from a user of the mobile device and thereafter communicate biometric related to the web resource for registration. According to the illustrated embodiment, the biometric related data communicated to the web resource comprises an original copy of the captured biometric data, biometric model parameters, a hash of the biometric data, a public portion of an asymmetric encryption token or a combination of the above. In one form, the registration page would allow the recipient 6 to choose one or more forms of biometric input, based on their preference. For example, they could provide just voice, or they may choose to provide a combination of photo, video, iris, 3D face structure, voice and fingerprint (also depending on the mobile device biometric input capability). In a particular embodiment, before a recipient 6 is allowed to enter their biometric data they must first authenticate themselves. In this embodiment, the registration page may ask them one or more validation questions (e.g. their date of birth, mother's maiden name, etc.), with the answers having been previously provided to the secure service 2 (e.g. supplied by the content originator, for example as part of a prior-registration option, as will be described in more detail in subsequent paragraphs). In another embodiment, the registration page may ask them to provide an image copy of a government ID or to capture the machine data contained in a passport (for example, by using the mobile phone's NFC sensor capabilities). The biometric capture session may be implemented, for example, by way of a HTML media capture process that is initiated by the web resource. The HTML Media Capture may involve the secure proxy service 2 serving an HTML webpage comprising a HTML form using HTML Media Capture form elements. The recipient 6 clicks a form button to have the browser initiate photo/video/voice capture. Then the recipient 6 then clicks a submit button to have the HTML form submitted to the secure proxy service 2. Alternatively, the web resource may provide a MediaStream API that implements the biometric capture session. For Media Capture and Streams, the secure proxy service 2 presents an HTML page that includes client-side Javascript code, such that when the recipient 6 clicks a button, the Javascript is executed, which causes the browser to record video. This video is them transmitted via Javascript (not a form submission) to the secure proxy service 2 for verification. Both the above options (HTML form and Javascript) may be presented in the one page, allowing the recipient 6 to choose based on their own browser capabilities, or the secure proxy service 2 may only present a preferred option based on detected client capabilities (e.g. inferred from a browser User Agent string). The original copy of the captured biometric data, the biometric model parameters, a hash of the biometric data, the public portion of an asymmetric encryption token or a combination of the above is subsequently stored in the biometric data store 12 in association with the unique identifier.

Second Pass

Once the biometric data has been registered for the recipient, they are ready to receive secure messages from the content originator 4. This is referred to as the “second pass”. A first step of the second pass (step S6) involves the secure service 2 generating a proxied URL for the secured content (i.e. a URL which directs a requesting browser first to the secure service 2, before being proxied to the secure content). The proxied URL may or may not be a re-written (and possibly shortened) version of the original URL. A hyperlink for the proxied URL is communicated to the recipient 6 in a second SMS at step S7.

It will be understood that the second pass may be initiated immediately following the first pass, or at some later time (which may or may not be predefined by the service). If the two passes are within close succession, it is possible for an eavesdropper to intercept, and act upon, both the first and second SMS messages before the intended recipient 6 has responded to the first SMS message. Thus, the eavesdropper could get access to the secured content within this short time period. Once the intended recipient 6 has responded to either message, the biometric data is invalidated, and customer and/or recipient notified, so in that case the interception is detectable, and the eavesdropper's access is not sustained. The probability of this risk occurring is inversely proportional to the period between the two messages, and thus a longer period allows more time for the intended recipient to respond to the first message, and invalidate the intercepted token, before the second message is sent. It will be understood that the delay could be varied by the secure service 2 depending on the desired implementation and specifications prescribed by the content originator 4.

At step S8, the recipient 6 attempts to access the proxied URL contained in the second SMS. More particularly, responsive to the recipient 6 selecting the hyperlink, the resident browser sends a request to the proxied URL. At step S9, the secure service 2 subsequently initiates an authentication session with the mobile device 6a, whereby the mobile device is controlled to capture biometric data from a user of the mobile device and thereafter communicate the captured biometric data to the web resource for authentication. As for the registration session, this may be implemented either by way of a HTML media capture process, or by way of a MediaStream API. Once the biometric data has been received, the secure service implements one or more authentication engines for comparing the captured biometric data against the previously registered biometric data. In an embodiment the MSIDN of the mobile device 6a is used for looking up the registered biometric data (although any suitable form of unique device identifier tied to the registered biometric data could be used). So, for example, multiple content originators benefit from the same registered biometric data. Or put another way, the first pass only happens once per recipient, not per content originator.

It will be understood that the authentication techniques implemented by the secure service 2 depend on the biometric data being tested. For example, voice data may be tested using one or more voice authentication engines, whereby a sample of the recipient's voice 6 is received as a voice file which is tested against a voiceprint that was created, using techniques well understood in the art, from a voice sample provided by the legitimate user during registration. Where the likelihood score is greater than a predefined threshold, the recipient 6 providing the voice sample is deemed legitimate and passes authentication. Image based authentication may involve generating a faceprint that is derived from one or more captured facial features (e.g. relative locations of eyes, eyebrows and nose shape). The faceprint is then compared, using one or more pattern matching algorithms, against an image that the legitimate user provided during registration. Alternatively, biometric authentication may be performed by an artificially intelligent engine trained on the previously registered biometric data.

If the secure service 2 is unable to authenticate the user (e.g. the authentication score does not pass a predefined threshold and a predefined number of attempts have been made), the secure service 2 registers the request as a fraudulent attempt to access the secure content and may issue an alert to the content originator 4 and/or recipient 6 (step S11). If the secure service 2 is able to successfully authenticate the user, at step S10 the service 2 allows the browser of requesting device 6a to be proxied to the URL of the secure content. In an embodiment, strong encryption (e.g. TLS encryption) may be used for communications between the secure service 2 and the webserver 8.

### ALTERNATIVE EMBODIMENTS AND FURTHER TECHNICAL DESCRIPTION

In an alternative embodiment to that described above, a recipient 6 may register with the secure service 2 prior to being sent a message from the content originator 4. Using the previous medical practice scenario, a patient may opt-in to receiving “secure SMS delivery” of results, when giving their contact details to a medical practice receptionist. In another embodiment, an online web portal could be provided by the secure service for recipient registrations. Thus, the first pass of the method may be triggered by either a registration request, or automatically triggered by a secure SMS delivery being attempted for a recipient that has not yet provided biometric data.

Although preceding embodiments described the secure service 2 as an intermediary, it will be understood that the secure service 2 could be implemented directly by the message content originator 4 (i.e. as opposed to being implemented as a third-party service).

It will be understood that where the secure service 2 could act as an intermediary for any number of subscribing content originators and message recipients. Each message recipient 6 implements a mobile device 6a for receiving SMS messages from the secure service 2. As described herein, the mobile device 6a takes the form of a smartphone. It will be understood, however, that any network enabled mobile device (e.g. tablet computer, laptop with mobile broadband, etc.) could be utilised.

In an alternative embodiment to that described above, the secure service 2 may store/maintain the secure content on behalf of the content originator 4. For example, the secure content may be stored on the webserver 14.

The hyperlink included in the second pass message communication may take on different forms. For example, the hyperlink may be a text-based link. In other embodiments of the invention, the hyperlink may be an image or video. The hyperlink may also be accessed in numerous ways depending on the device used to access said unique hyperlink. For instance, the hyperlink may be selected using a finger on a touch screen, a keypad entry, using a stylus etc.

In an embodiment, a non-replyable alphanumeric source address could be utilised at least for the first pass SMS message sent by the secure server 2.

In yet another alternative embodiment, a device-based authentication could be carried out (i.e. as opposed to the secure service 2 performing the authentication) by submitting an authentication challenge to the device 6a. By way of example, the proxy service 2 may respond with either an Android Instant App link, or an Apple Universal Link directing the device 6a to a custom Secure SMS application that requests biometric data input from the recipient and performs authentication on the host device's OS and leverages a trusted biometrics processor. The secure server 2 would validate the authentication by using the public portion of the asymmetric token stored in the biometric data store 12.

As previously discussed, embodiments as described herein could be combined with the two-pass token-based authentication methodology as outlined in co-pending Australian provisional patent application No. 2017902935. Thus, during the first pass the device 6a may be both assigned a token and registered for biometric authentication (i.e. in response to replying to the first request message). During the second pass, the device 6a must pass both the token and biometric authentication tests before being proxied to the secure web resource.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

Any discussion of documents, acts, materials, devices, articles or the like which has been included in this specification is solely for the purpose of providing a context for the present invention. It is not to be taken as an admission that any or all of these matters form part of the prior art base or were common general knowledge in the field relevant to the present invention as it existed in Australia or elsewhere before the priority date of this application.

The preceding description is provided in relation to several embodiments which may share common characteristics and features. It is to be understood that one or more features of any one embodiment may be combinable with one or more features of the other embodiments. In addition, any single feature or combination of features in any of the embodiments may constitute additional embodiments.

In addition, the foregoing describes only some embodiments of the inventions, and alterations, modifications, additions and/or changes can be made thereto without departing from the scope and spirit of the disclosed embodiments, the embodiments being illustrative and not restrictive.

Furthermore, whilst the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of this disclosure. Also, the various embodiments described above may be implemented in conjunction with other embodiments, e.g., aspects of one embodiment may be combined with aspects of another embodiment to realize yet other embodiments. Further, each independent feature or component of any given assembly may constitute an additional embodiment.

1. A computer implemented method for sending secure content to a content recipient via a mobile device, the method comprising:
receiving a content delivery message containing a URL to a web resource containing the secure content, the URL being received by a third-party proxy service;
responsive to receiving the message, the third-party proxy service:
a) sends a message to the mobile device containing a proxied URL selectable for routing the mobile device to the secure content page, via the third-party proxy service;
b) receives a content request from the mobile device for accessing the proxied URL;
c) communicates with the mobile device to authenticate the user, based on biometric data provided by the user; and
d) responsive to determining that the user is the content recipient based on a positive authentication, proxying the content request to the web resource containing the secure content.

2. The method in accordance with claim 1, wherein step (c) comprises initiating a biometric capture session with the mobile device, the biometric capture session comprising controlling the mobile device to:
(i) capture biometric data from a user of the mobile device; and
(ii) communicate the captured biometric data to the web resource for authentication;
and wherein the web resource authenticates the user by comparing the captured biometric data against biometric data previously registered for the content recipient.

3. The method in accordance with claim 2, wherein the biometric capture session is implemented by way of a HTML media capture process that is initiated by the web resource.

4. The method in accordance with claim 2, wherein the web resource comprises a MediaStream API that implements the biometric capture session.

5. The method in accordance with claim 1, wherein step (c) comprises instructing the mobile device to initiate a device based authentication session, comprising:
(i) capture biometric data from a user of the mobile device; and
(ii) comparing the captured biometric data against biometric data previously registered with the mobile device for the content recipient.

6. The method in accordance with claim 1, wherein step (c) comprises instructing the mobile device to initiate a device based authentication session, comprising: issuing a cryptographic challenge that can only be solved by passing a local device based biometric authentication and then performing the required cryptographic operations on the device's trusted biometrics processor.

7. The method in accordance with claim 1, wherein the content request is proxied to the web resource containing the secure content using a predefined encryption technique.

8. The method in accordance with claim 1, wherein the content delivery message is intercepted by an API operated by the third-party proxy service.

9. The method in accordance with claim 1, wherein the messages sent and received by the third-party proxy service are SMS messages.

10. The method in accordance with claim 1, wherein the message sent by the third-party proxy service to the mobile device contains a hyperlink to the proxied URL which is selectable by the user.

11. A system for sending secure content to a content recipient via a mobile device, the system comprising:
a third-party proxy service configured to receive a content delivery message containing a URL to a web resource containing the secure content, responsive to receiving the message, the third-party proxy service further configured to:
a) send a message to the mobile device containing a proxied URL selectable for routing the mobile device to the secure content page, via the third-party proxy service;
b) receive a content request from the mobile device for accessing the proxied URL;
c) communicate with the mobile device to authenticate the user, based on biometric data provided by the user; and
d) responsive to determining that the user is the content recipient based on a positive authentication, proxying the content request to the web resource containing the secure content.
